(19) United States
(12) Patent Application Publication
(10) Pub. No.: US 2007/0053442 A1
(43) Pub. Date: Mar. 8, 2007

(54) Separation markers in fine granularity scalable video coding

(75) Inventors: Justin Ridge, Sachse, TX (US); Marta Karczewicz, Irving, TX (US); Yiliang Bao, Coppell, TX (US); Xianglin Wang, Santa Clara, CA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/510,257

(22) Filed: Aug. 25, 2006

Related U.S. Application Data
(60) Provisional application No. 60/711,568, filed on Aug. 25, 2005.

(51) Int. Cl. H04N 11/04

(52) U.S. Cl. 375/240.24

(57) ABSTRACT

When coding a fine granularity scalability layer separated by color components, a marker is provided to signal the end of each color component. In particular, markers are used to separate luminance (Y) component from chrominance components (U,V) so that the chrominance components can be discarded in the truncation of the FGS layer. A different marker may be used to indicate the location of the color separation marker. In video editing, the chrominance components of encoded video data of the FGS layer are stored while the luminance component is decoded so that video effects can be applied to the luminance component. In the base layer, the luminance component is extracted from the decoded base layer for video effect application.

The patent application is based on and claims priority to U.S. patent application Ser. No. 60/711,568, filed Aug. 25, 2005, assigned to the assignee of the present invention.

### FIELD OF THE INVENTION

The present invention relates generally to video coding and, more particularly, to scalable video coding.

### BACKGROUND OF THE INVENTION

Fine Granularity Scalability (FGS) has recently been added to the MPEG-4 AVC video coding standard in order to increase the flexibility of video coding. With FGS coding, the video is encoded into a base layer (BL) and one or more enhancement layers or FGS layers, as shown in FIG. 1. Similar to conventional scalable video coding, the base layer must be received completely in order to decode and display a basic quality video. In contrast to conventional scalable video coding, which requires the reception of complete enhancement layers to improve upon the basic video quality, with FGS coding the enhancement layer stream can be cut anywhere before transmission or during decoding. In other words, the bitstream of an FGS layer can be arbitrarily truncated for each frame. Thus, FGS allows the quality of a video signal to be incrementally improved by decoding additional information from an FGS layer. If a device receives the video stream over a low rate channel, the decoded video may be of a lower quality. If a device receives the same video stream over a higher-rate channel, the decoded video may be of a higher quality. Truncating the FGS layer permits decoding at essentially arbitrary bitrates above that of the base layer. Truncating a bitstream may affect the coding efficiency.

It is known that the colors in video data can be represented by a mixture of three primaries colors of R, G, B. However, various equivalent color spaces are also possible. Many important color spaces comprise a luminance component (Y) and two chrominance components (U, V). Truncation can be related to the color space representation.

### SUMMARY OF THE INVENTION

The present invention is concerned with the truncation of an FGS layer and the coding efficiency of the truncated bitstream. In the case where the data in an FGS layer is separated by color components, the present invention uses a marker to signal the end of each color component. For example, in the YUV color space, the Y component data may be sent before the U and V component data. Inserting a marker into the bitstream between the Y component and the (U, V) components facilitates truncation of the FGS layer at the marker so that the data to be decoded contains only Y component data.

Thus, the first aspect of the present invention is a method for embedding scalable video data in a bitstream. The method comprises separating the scalable video data into a base layer part and a fine granularity scalability part; encoding the base layer part for providing an encoded base layer part; providing at least one marker symbol indicative of a transition from one color component to another color component in the fine granularity scalability part for providing one or more marked fine granularity scalability parts;

encoding the one or more marked fine granularity scalability part for providing an encoded fine granularity scalability part; and combining the encoded base layer part and the encoded fine granularity scalability part into the bitstream.

The second aspect of the present invention is a method for decoding scalable video data from a bitstream of encoded data. The method comprises separating the encoded data into a base layer part and a fine granularity scalability part, wherein the fine granularity scalability part comprises at least one marker symbol indicative of a transition between a first color component and a second color component; decoding the base layer part for providing a decoded base layer part; and decoding the fine granularity scalability part having the first color component based on said at least one marker symbol, using the decoded base layer part as reference, and wherein the first color component comprises a luminance color component and the second color component comprises chrominance color components.

The third aspect of the present invention provides a video encoder for encoding scalable video data. The video encoder comprises means for separating the scalable video data into a base layer part and a fine granularity scalability part; means for placing at least one marker symbol indicative of a transition between one color component and another color component in the fine granularity scalability part for providing one or more marked fine granularity scalability parts, and means for encoding the base layer part and the marked fine granularity scalability part and for embedding the encoded base layer part and the encoded fine granularity scalability part into the bitstream.

The fourth aspect of the present invention is a mobile terminal comprising a video encoder as described above.

The fifth aspect of the present invention is a video decoder for decoding scalable video data from a bitstream. The decoder comprises means for decoding a base layer part in the video data for providing a decoded base layer part, for decoding at least a luminance component in a fine granularity scalability part of the video data, wherein the fine granularity scalability part comprises at least one marker symbol indicative of a transition between the luminance component and chrominance components, wherein said decoding of the fine granularity scalability part is based on the decoded base layer part; and means for detecting said at least one marker symbol so as to allow the first module to separate the luminance component from the chrominance components.

The sixth aspect of the present invention is a mobile terminal comprising a video decoder as described above.

The seventh aspect of the present invention is a software application product comprising a storage medium having a software application for use in a video encoder for embedding scalable video data in a bitstream, said software application comprising programming codes for providing at least one marker symbol indicative of a transition from one color component to another color component in the video data, wherein the video data comprises a base layer part and a fine granularity scalability part; and said at least one marker symbol is placed at least in the fine granularity scalability part, and for placing a further marker symbol indicative of a location of said at least one marker symbol in the fine granularity scalability part.

The eighth aspect of the present invention is a software application product comprising a storage medium having a software application for use in a video decoder for decoding scalable video data in a bitstream. The software application comprises programming code for detecting at least one marker symbol indicative of a transition between one color component and another color component in the video data, wherein the video data comprises a base layer part and a fine granularity scalability part; and said at least one marker symbol is placed at least in fine granularity scalability part; and programming code for detecting a further marker symbol indicative of a location of said at least one marker symbol in the fine granularity scalability part.

The present invention will become apparent upon reading the description taken in conjunction with FIG. 1 to 11.

### BRIEF DESCRIPTION OF THE DRAWINGS

FIG. 1 is a schematic representation of MPEG-4 fine granularity SNR scalability.

FIGS. 2a to 2c illustrate the formation of a macroblock, wherein FIG. 2a shows a frame of video sequence; FIG. 2b illustrates macroblocks formed by representing a region of 16×16 image pixels; and FIG. 2c shows the sizes of the luminance block and the corresponding chrominance components.

FIG. 3 shows the boundary between two color components in a bitstream in prior art.

FIG. 4 shows the marker symbol at the boundary between two color components in a bitstream, according to one embodiment of the present invention.

FIG. 5a shows additional marker symbols to indicate the length or location of color components, according to another one embodiment of the present invention.

FIG. 5b shows additional marker symbols to indicate the length of color components, according to yet another embodiment of the present invention.

FIG. 6 is a block diagram showing an FGS encoder with base-layer-dependent formation of reference blocks.

FIG. 7 is a block diagram showing an FGS decoder with base-layer-dependent formation of reference blocks.

FIG. 8 is a block diagram showing a video editor that can be used to discard the chrominance components in a video stream.

FIG. 9 is a flowchart illustrating a method of video editing, according to one embodiment of the present invention.

FIG. 10 is a flowchart illustrating a method of decoding scalable video data having a FSG layer in a bitstream.

FIG. 11 is a block diagram showing an electronic device having at least one of the scalable encoder and the scalable decoder, according to the present invention.

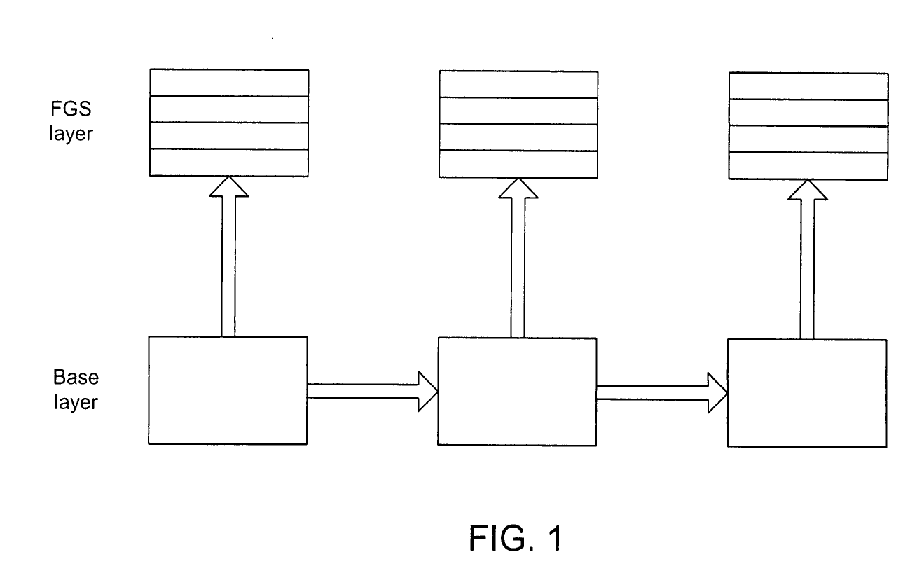

### DETAILED DESCRIPTION OF THE INVENTION

A digital video sequence, like an ordinary motion picture recorded on film, comprises a sequence of still images, the illusion of motion being created by displaying consecutive images of the sequence one after the other at a relatively fast rate, typically 15 to 30 frames per second. Because of the relatively fast frame display rate, images in consecutive frames tend to be quite similar and thus contain a considerable amount of redundant information. For example, a typical scene may comprise some stationary elements, such as background scenery, and some moving areas, which may take many different forms, for example the face of a newsreader, moving traffic and so on. Alternatively, or additionally, so-called “global motion” may be present in the video sequence, for example due to translation, panning or zooming of the camera recording the scene. However, in many cases, the overall change between one video frame and the next is rather small.

Each frame of an uncompressed digital video sequence comprises an array of image pixels. For example, in a commonly used digital video format, known as the Quarter Common Interchange Format (QCIF), a frame comprises an array of 176×144 pixels, in which case each frame has 25,344 pixels. In turn, each pixel is represented by a certain number of bits, which carry information about the luminance and/or color content of the region of the image corresponding to the pixel. Commonly, a so-called YUV color model is used to represent the luminance and chrominance content of the image. The luminance, or Y, component represents the intensity (brightness) of the image, while the color content of the image is represented by two chrominance or color difference components, labelled Uand V.

Color models based on a luminance/chrominance representation of image content provide certain advantages compared with color models that are based on a representation involving primary colors (that is Red, Green and Blue, RGB). The human visual system is more sensitive to intensity variations than it is to color variations and YUV color models exploit this property by using a lower spatial resolution for the chrominance components (U, V) than for the luminance component (Y). In this way, the amount of information needed to code the color information in an image can be reduced with an acceptable reduction in image quality.

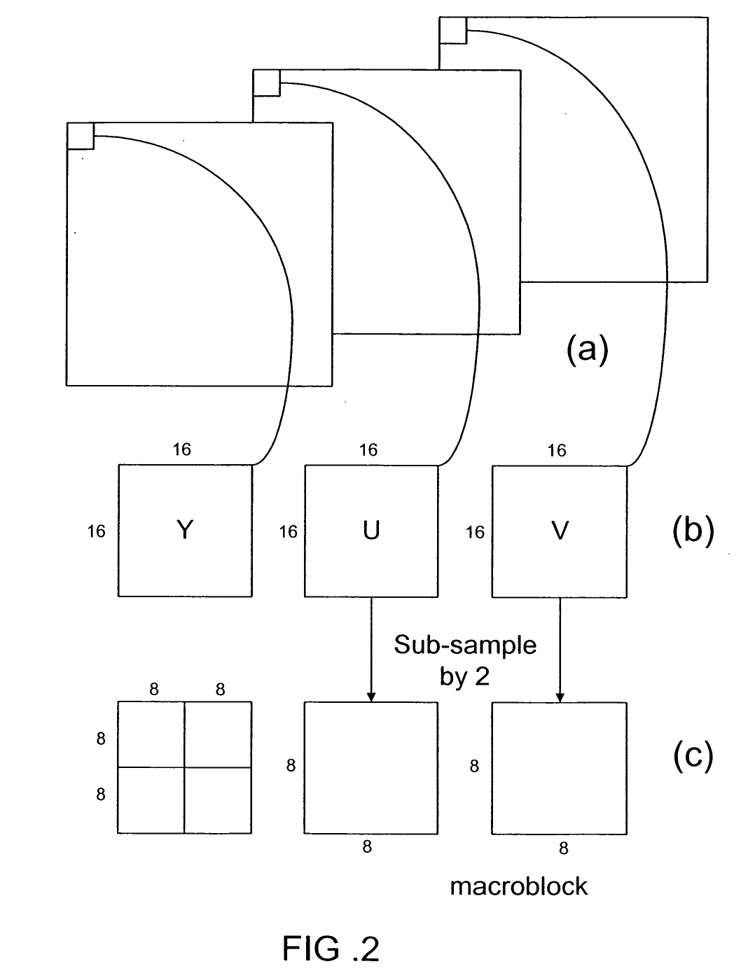

The lower spatial resolution of the chrominance components is usually attained by spatial sub-sampling. Typically, each frame of a video sequence is divided into so-called “macroblocks”, which comprise luminance (Y) information and associated (spatially sub-sampled) chrominance (U, V) information. Macroblocks represent some region of pixels in the original image, generally a 16×16 square. The luminance component of the macroblock may be divided into blocks, for example four 8×8 blocks. In color formats where the chrominance components are spatially sub-sampled, the number of chrominance values in a macroblock will be correspondingly reduced. For example, if the chrominance resolution is halved, each macroblock will contain only one 8×8 block for each of the chrominance (U, V) components, as shown in FIG. 2.

For such macroblock-based coders, luminance information for a given macroblock generally occurs before chrominance information from the same macroblock in the bit stream. That is, luminance information from a first macroblock is coded into a bit stream, followed by chrominance information from that same macroblock, followed by luminance information from a second macroblock, and so on.

FIGS. 2a-2c illustrate one way in which macroblocks can be formed. FIG. 2a shows a frame of a video sequence represented using a YUV color model, each component having the same spatial resolution. Macroblocks are formed by representing a region of 16×16 image pixels in the original image (FIG. 2b) as four blocks of luminance information, each luminance block comprising an 8×8 array of luminance (Y) values and two spatially corresponding chrominance components (U and V) which are sub-sampled by a factor of two in the horizontal and vertical directions to yield corresponding arrays of 8×8 chrominance (U, V) values (see FIG. 2c).

The luminance (Y) and chrominance (U, V) components are encoded sequentially and separately using spatial, temporal or inter-layer prediction. That is, chrominance information is encoded following luminance information on a per-macroblock basis.

In some cases, it is of interest to extract only one color component in the video data for video analysis or editing purposes. Directly extracting only the desired color component or components from video data would reduce the amount of decoding and computational complexity. It would be advantageous if only the Y color component, for example, could be extracted from the YUV video.

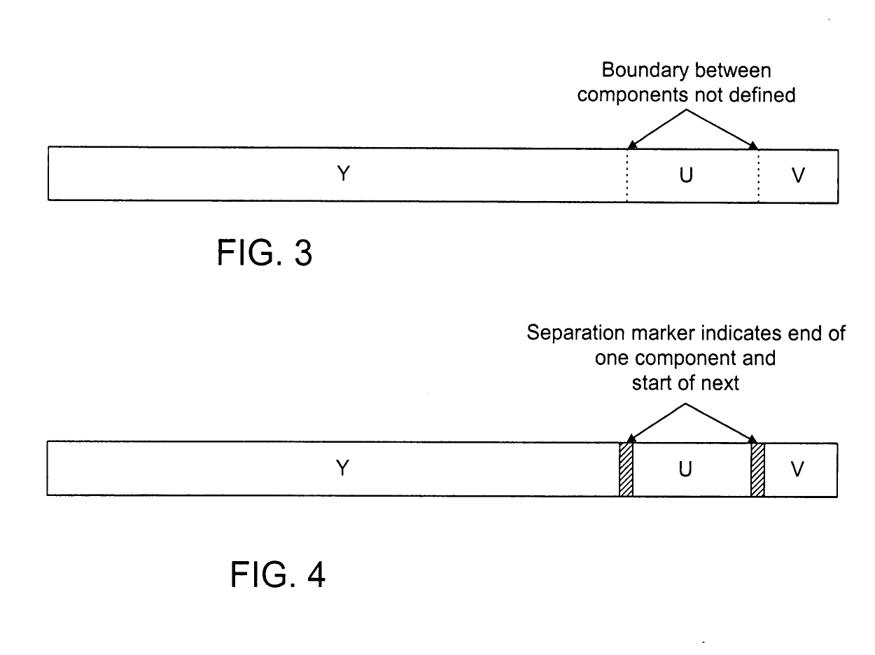

In the existing draft of progressive refinement (FGS) slices in H.264/AVC Annex F, a mechanism does exist whereby data from each color component is coded contiguously within a slice (FIG. 3), however it is difficult to determine when one component ends and another component begins without decoding the preceding color components from the FGS layer. The present invention adds markers between the color components (FIG. 4), so that extracting a single color component becomes straightforward.

In the case where the data in an FGS layer is separated by color components, the present invention uses a maker to signal the end of each color component. For example, in the YUV color space, all the Y component data may be sent before any of the U and V component data in a slice. Inserting a marker into the bitstream between the Y component and the (U, V) components facilitates truncation of the FGS layer at the marker so that the data to be decoded contains only Y component data.

A marker symbol, according to the present invention, can be used to indicate the transition from one color component to another color component. FIG. 4 illustrates a marker symbol inserted between Y and U color components in the video data in the bitstream to indicate the end of the Y color component and the beginning of the U color component. Likewise, another marker symbol may be inserted between U and V color components. In some applications, for example video editing, one component should be easily extracted, but other components need not be distinguished. Thus, a marker may exist after the Y color component but not between the U and V color components.

In another embodiment of the present invention, a flag such as fgs_component_ordering flag is used to indicate whether video data from the color components is interleaved or whether video data from each color component is arranged in consecutively in the bitstream. The marker symbols are only decoded if this flag exists and is set.

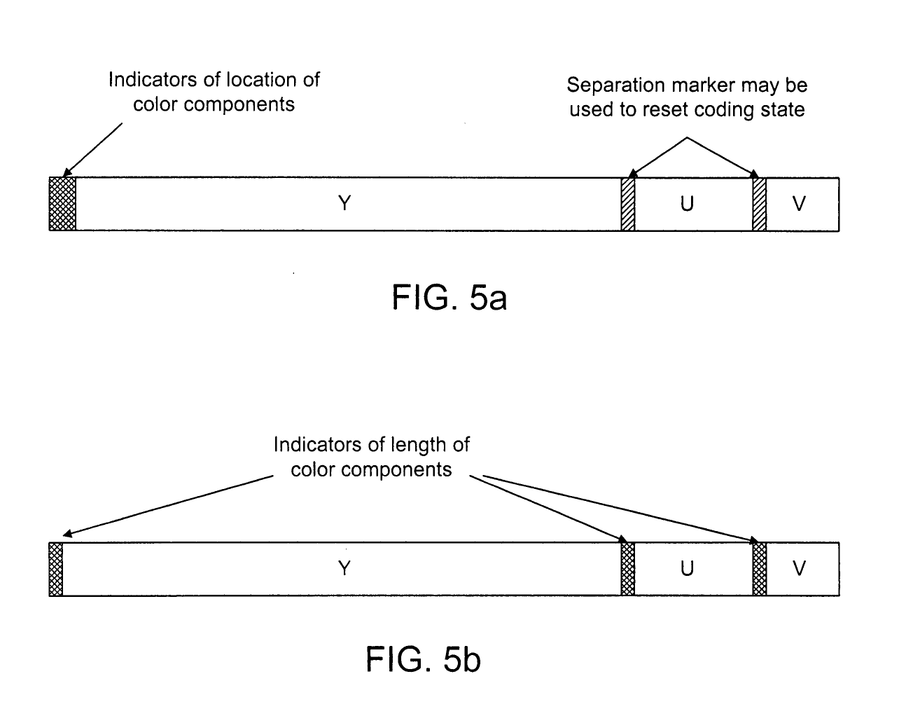

In yet another embodiment of the present invention, marker symbols can be used to indicate the location of color components in the bitstream, as shown in FIG. 5a. In this embodiment, there are two types of marker symbols: one is used to indicate the location of color components and the other is used to reset coding state. In a further embodiment of the present invention, the second type of marker symbol used to reset the coding state is only decoded in situations where a particular type of entropy coder, such as an arithmetic coder requiring a state reset, is used for decoding the FGS layer. In a different embodiment of the present invention, the second type of marker symbol used to reset the coding state is only decoded in situations where a flag indicates that a particular type of entropy coder is used for decoding the FGS layer.

In another embodiment of the present invention, marker symbols can be used to indicate the size or length of color components. They may precede each color component, as shown in FIG. 5b, or may all be coded prior to the first color component.

In yet another embodiment of the present invention, a flag such as fgs_component_ordering flag is used to indicate whether video data from the color components is interleaved or whether video data from each color component is arranged in consecutively in the bit stream. The marker symbols indicating the length of each component are only decoded if this flag exists and is set.

Overview of the FGS Coder

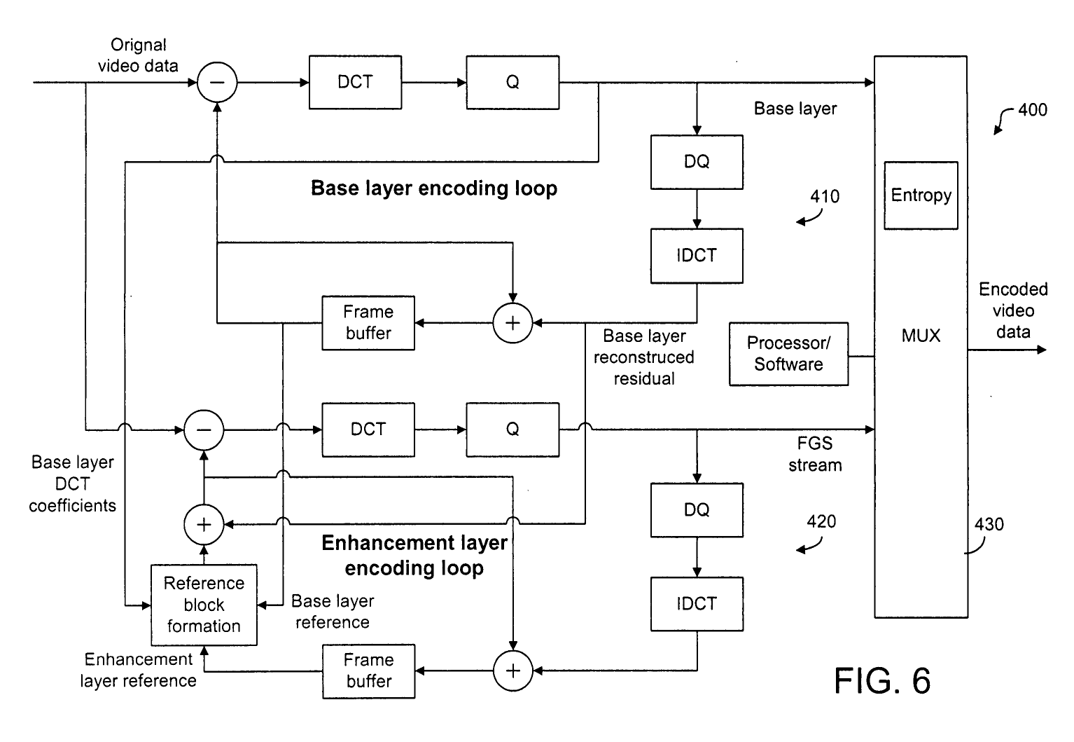

FIG. 6 is a block diagram of the FGS encoder wherein the formation of reference blocks is dependent upon the base layer. In this block diagram, only one FGS layer is shown. However, it should be appreciated that the extension of one FGS layer to a structure having multiple FGS layers is straightforward.

As shown in FIG. 6, the FGS encoder 400 has two coding modules 410 and 420. The coding module 410 has a base-layer encoding loop to produce a bitstream of a base layer. The coding module 420 has an enhancement layer encoding loop to produce a FGS stream. The coding module 420 has a reference block formation module for the formation of reference blocks based upon the base layer DCT coefficients. In the event “motion refinement” is used, the reference block formation for some blocks may be replaced with a motion-compensated block from a previous FGS frame, i.e. not from the base layer.

The base layer bitstream and the FGS stream are combined in a multiplexer 430 into an encoded bitstream. The multiplexer unit 430 receives motion vector information, coding mode information and the transform coefficients for each luma and chroma component blocks of a macroblock in a frame. The multiplexer may reorganize certain received information and performs an entropy encoding operation, and outputs the final encoded bitstream. The multiplexing module comprises an entropy coding module and may also incorporate a reorganization module. The reorganization module reorganizes the coefficients of the enhancement layer from different blocks in a frame into subbands prior to entropy coding by the entropy encoding module. The reorganization module may interleave chrominance values with the luminance values, so that on average a chrominance value follows every fourth luminance value due to spatial sub-sampling of the chrominance components. Alternatively, the reorganization module may defer coding of any chrominance values until all luminance values in the slice have been coded.

When the reorganization module operates in the second mode, is possible to insert the markers to delimit the chrominance components while the base layer stream and the FGS stream of different color components are multiplexed into the encoded bitstream. For that purpose, the reorganization module is associated with a processing component or a software module for marker insertion purposes.

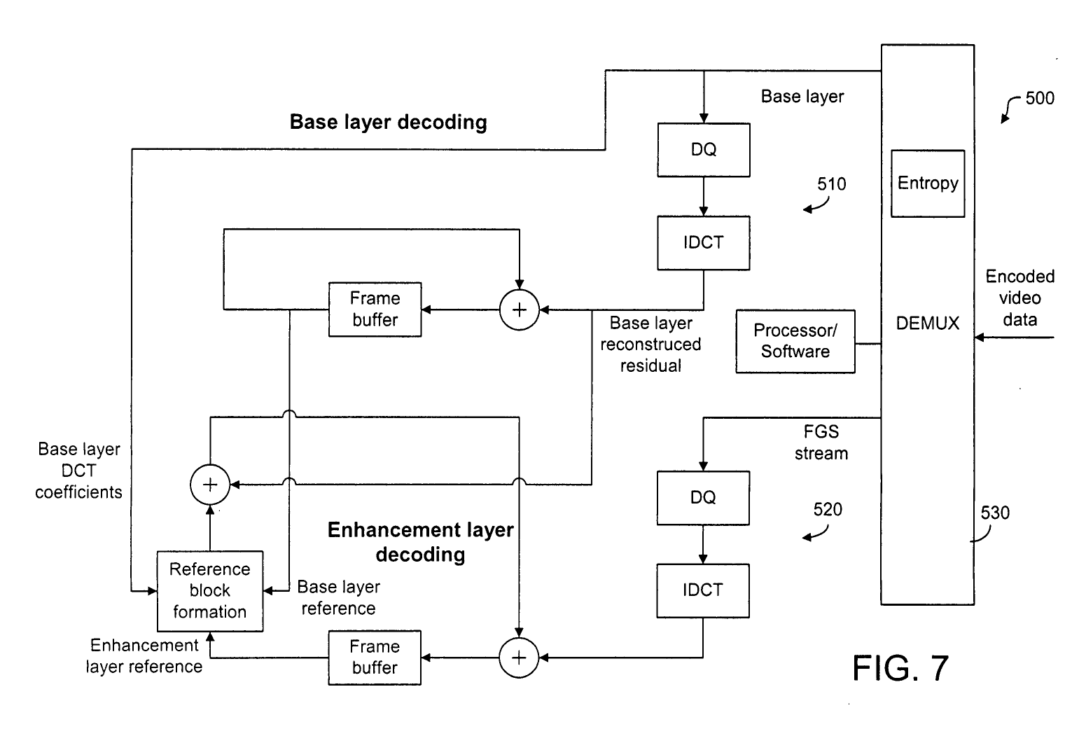

FIG. 7 is a block diagram of the FGS decoder wherein the formation of reference blocks is dependent upon the base layer. In this block diagram, only one FGS layer is shown. However, it should be appreciated that the extension of one FGS layer to a structure having multiple FGS layers is straightforward.

As shown in FIG. 7, the FGS decoder 500 has a demultiplexer 530 and two decoding modules 510 and 520. After the demultiplexer 530 separates an encoder bitstream into an encoded base layer stream and an encoded FGS bitstream, the base layer module 510 is used to decode the encoded base layer stream and the FGS decoding module 520 is used to decode the encoded FGS stream.

The decoding module 520 has a reference block formation module for the formation of reference blocks based upon the base layer DCT coefficients. Following entropy decoding by an entropy decoding module, a reorganization module rearranges coefficients into a block-based order. In one mode of operation, luminance and chrominance coefficients are interleaved in the bit stream. In a second mode of operation, the luminance coefficients precede all chrominance coefficients in a given slice. The entropy decoding modules may be incorporated in the demultiplexer 530.

It is possible to associate a processing component or a software program to detect the component separation markers while the reorganization module is rearranging coefficients into a block-based structure.

When the markers in the encoded bitstream are detected by the processor component or the software program in the reorganization process, the reorganization module may throw away the parts related to the chrominance components in the FGS layer. The reorganization module and entropy decoding module may be merged so that those parts that are discarded do not need to be processed by the entropy decoding module.

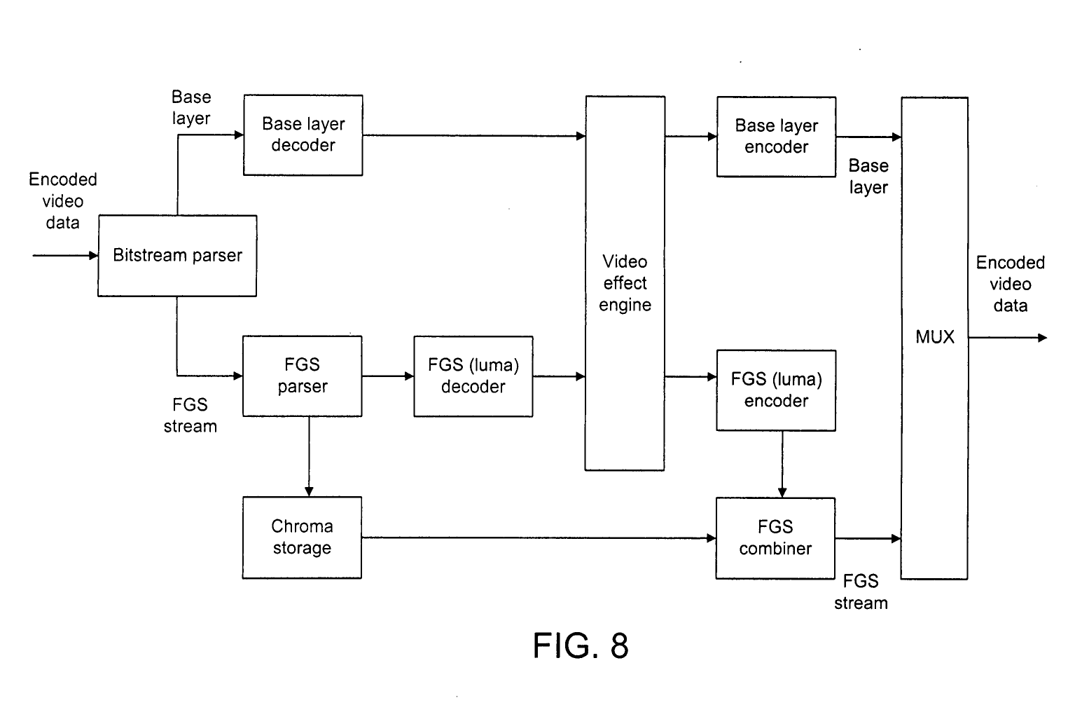

In case of video editing, the editor may discard the parts belonging to the chrominance components after determining the locations/positions using the markers and then re-stores a new edited bitstream. FIG. 8 is a block diagram illustrating such a video editing device. As shown in FIG. 8, the video editing processor or software program has a marker detection module for determining the locations/positions of the chrominance components based on the markers. The video editing processor further comprises a component selection module to discard the chrominance components based on their locations or positions in the bitstream. As shown in FIG. 8, the video editing device has a parser to parse a bitstream containing encoded video data into a base layer part and an FGS enhancement part. A base layer decoder is used to decode the base layer part and an FGS parser is used to separate the FGS enhancement part into a luminance component and chrominance components. A processing component or software product is used to detect the markers in one or both of the base layer part and the FGS enhancement part. The chrominance components are stored in a storage device. An FGS decoder is used to decode the luminance component. A video effect engine may apply one or more video effects to the luminance component in the base layer part and the luminance component in the FGS enhancement part. A base layer encoding module is used to re-code the decoded base layer part and an FGS encoding module is used to re-code the luminance component in the FGS enhancement part. An FGS combination module is used to combine the re-coded luminance component in the FGS enhancement part and the stored chrominance components. The combined FGS enhancement part and the re-coded base layer part are embedded in a bitstream by a multiplexer.

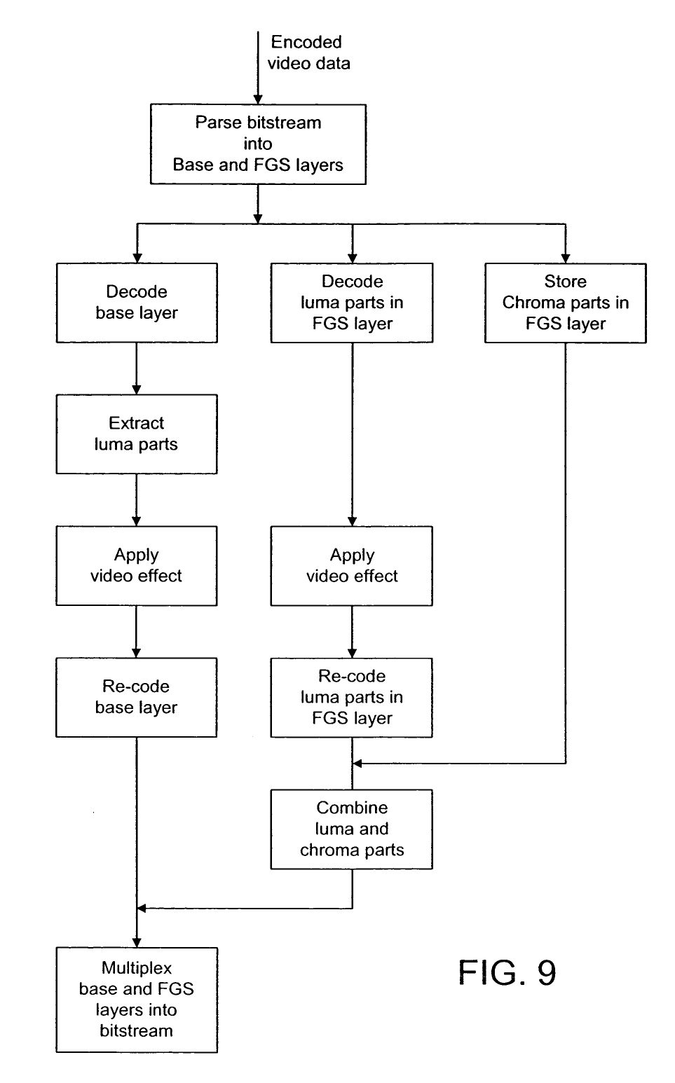

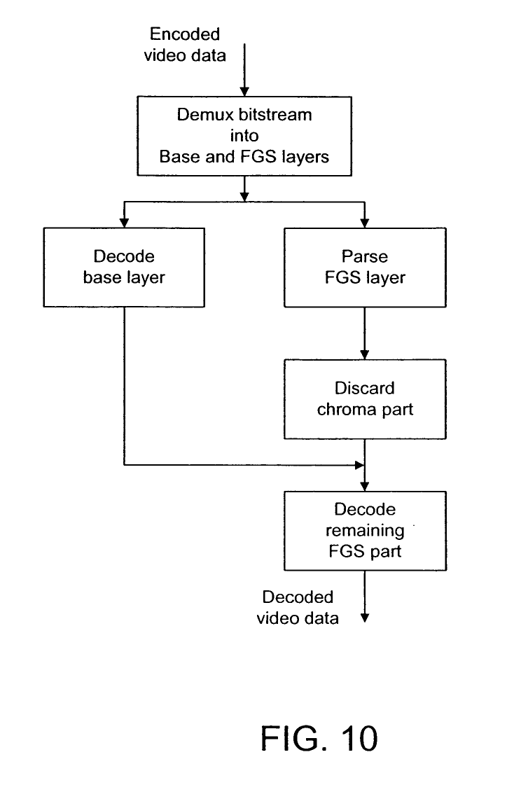

FIG. 9 is a flowchart illustrates a method of video editing, according to an embodiment of the present invention. FIG. 10 is a flowchart illustrates a method of decoding scalable video data having a FGS layer in a bitstream.

As shown in the flowchart in FIG. 9, a bitstream having encoded video data is parsed into a base layer part and an FGS enhancement part. The FGS enhancement part is parsed so that the color component separation markers are detected, and the color components are separated into luminance and chrominance. The chrominance components in the FGS enhancement part are stored in a storage medium while the luminance component in the FGS enhancement part is decoded. The base layer part is also decoded by a separate decoder. The luminance component in the decoded base layer part is extracted so that a video effect, such as brightness adjustment, may be applied to the luminance component. Similarly, a video effect may be applied to the decoded luminance component in the FGS enhancement part. The base layer and the luminance component of the FGS enhancement part are re-coded. The re-coded luminance component of the FGS enhancement part is recombined with the stored chrominance components. The combined FGS enhancement part and the re-coded base layer part are multiplexed into the bitstream.

As shown in the flowchart in FIG. 10, a bitstream having encoded video data is separated into a base layer part and an FGS enhancement part by a demultiplexer. The base layer part is decoded separately. The FGS enhancement part is parsed so that some or all of the chrominance components in the FGS enhancement part may be discarded. The remaining FGS enhancement part is then decoded using the decoded base layer part as reference.

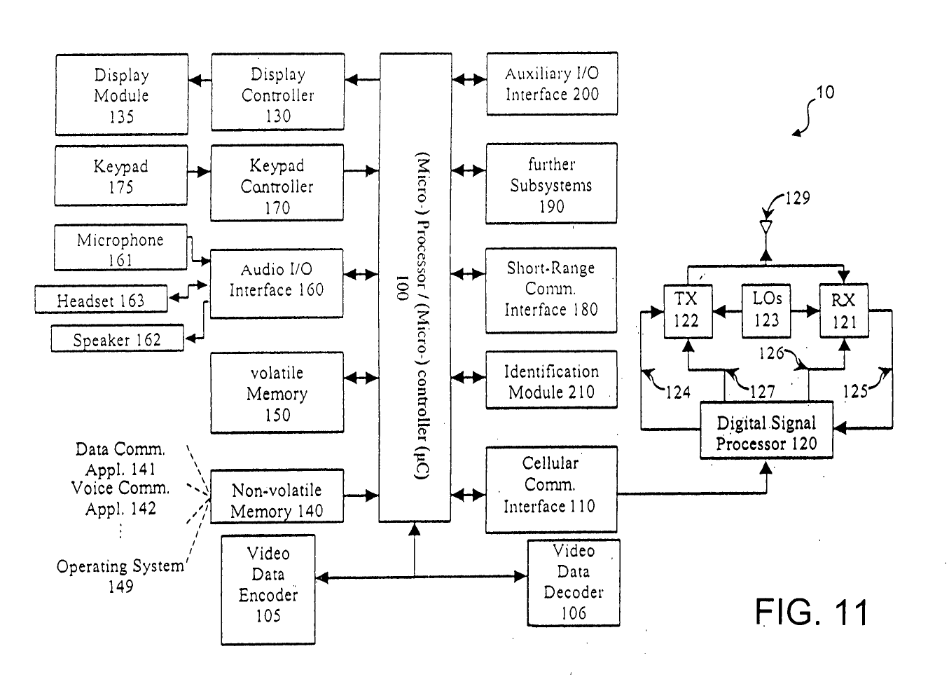

FIG. 11 depicts a typical mobile device according to an embodiment of the present invention. The mobile device 10 shown in FIG. 11 is capable for cellular data and voice communications. It should be noted that the present invention is not limited to this specific embodiment, which represents for the way of illustration one embodiment out of a multiplicity of embodiments. The mobile device 10 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network. The cellular communication interface subsystem as depicted illustratively with reference to FIG. 11 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 122. In case the mobile device 10 communications through the PLMN occur at a single frequency or a closely-spaced set of frequencies, then a single local oscillator (LO) 128 may be used in conjunction with the transmitter (TX) 122 and receiver (RX) 121. Alternatively, if different frequencies are utilized for voice/ data communications or transmission versus reception, then a plurality of local oscillators 128 can be used to generate a plurality of corresponding frequencies. Although the antenna 129 depicted in FIG. 11 or a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 100 is intended to operate.

After any required network registration or activation procedures, which may involves the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprise especially USB (universal serial bus) interface, serial interface, MMC (multimedia card) interface and related interface technologies/standards, and any other standardized or proprietary data communication bus technology, whereas the short-range communication interface radio frequency (RF) low-power interface including especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation. Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in form of a cellular phone. The present invention is not limited to these specific components and their implementation depicted merely for the way for illustration and sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. Especially the implementation of enhanced multimedia functionalities includes for example reproducing of video streaming applications, manipulating of digital images, and video sequences captured by integrated or detachably connected digital camera functionality but also gaming applications with sophisticated graphics drives the requirement of computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprise of a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology caused that very-large-scale integration (VLSI) integrated circuits enable a significant grow in complexity, making it possible to integrate numerous components of a system in a single chip. With reference to FIG. 11, one or more components thereof, e.g. the controllers 130 and 160, the memory components 150 and 140, and one or more of the interfaces 200, 180 and 110, can be integrated together with the processor 100 in a signal chip which forms finally a system-on-a-chip (Soc).

Additionally, said device 10 is equipped with a module for scalable encoding 105 and scalable decoding 106 of video data according to the inventive operation of the present invention. By means of the CPU 100 said modules 105, 106 may be individually be used. However, said device 10 is adapted to perform video data encoding or decoding respectively. Said video data may be received by means of the communication modules of the device or it also may be stored within any imaginable storage means within the device 10.

In sum, the present invention provides a method and encoder for embedding scalable video data in a bitstream. The encoder is adapted for separating the scalable video data into a base layer part and a fine granularity scalability part; encoding the base layer part for providing an encoded base layer part; providing at least one marker symbol indicative of a transition from one color component to another color component in the fine granularity scalability part for providing one or more marked fine granularity scalability parts; encoding the one or more marked fine granularity scalability parts for providing an encoded fine granularity scalability part; and combining the encoded base layer part and the encoded fine granularity scalability part into the bitstream, wherein said at least one marker symbols occur and indicate offsets within the bitstream at which the transitions from one color component to another component occur, and wherein the video data in each color component in the bitstream has a length, and the marker symbol is indicative of the length of at least one color component.

Advantageously, the video data for a given one of the color components in a plurality of frames is located consecutively in the bitstream and the marker symbol is indicative of an end of said given color component in said plurality of frames.

Advantageously, the bitstream further comprises a flag, the flag indicating whether the video data from the color components is interleaved or whether the video data from each of the color components is arranged consecutively in the bitstream, and wherein said at least one marker symbol is decoded only if the flag is set.

Advantageously, the at least one marker symbol is indicative of the location of a given one of the color components and the encoder is adapted to provide a different marker symbol indicative of resetting a coding state and a flag in the bitstream indicative of a given type of decoder so that the different marker symbol is decoded only when the video data is decoded by the given type of decoder.

The present invention also provides a method and decoder for decoding scalable video data from a bitstream of encoded data. The decoder is adapted for separating the encoded data into a base layer part and a fine granularity scalability part, wherein the fine granularity scalability part comprises at least one marker symbol indicative of a transition between luminance component and chrominance components; decoding the base layer part for providing a decoded base layer part; and decoding the fine granularity scalability part, using the decoded base layer part as reference.

Advantageously, a further marker is used to indicate the location of said at least one marker symbol so that the fine granularity scalability part is decoded also based on the further marker symbol.

Advantageously, the at least one marker symbol comprises a plurality of markers, and the markers occur consecutively and indicate offsets in the bitstream at which the transitions between the first color component and the second color component occur.

Advantageously, the marker symbol is indicative of the length of at least one color component in the bitstream.

Advantageously, the bitstream further comprises a flag, the flag indicating whether the video data from the color components is interleaved or whether the video data from each of the color components is arranged consecutively in the bitstream, and wherein the at least one marker symbol is decoded only if the flag is set.

Advantageously, the at least one marker symbol is indicative of a location of at least one of the first and second color components, and a different marker symbol indicative of resetting a coding state, and the decoder is adapted for providing a flag in the bitstream to indicate a given type of decoder; and decoding the different marker symbol only when the video data is decoded using said given type of decoder.

The present invention provides an electronic device, such as a mobile terminal, having one or both of the encoder and decoder as described above.

The present invention provides a software application product having programming codes to carry out the encoding method as described above.

The present invention also provides a software application product having programming codes to carry out the decoding method as described above.

It should be noted that the detection of the color component separation markers in the video decoding process and the video editing process can be carried out before entropy decoding. Furthermore, the block diagrams as shown in FIGS. 6-9 and the flowcharts as shown in FIGS. 9 and 10 are for illustration purposes only. They are used to illustrate the principle of present invention and they represent only certain embodiments of the present invention.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for embedding scalable video data in a bitstream, comprising:
separating the scalable video data into a base layer part and a fine granularity scalability part;
encoding the base layer part for providing an encoded base layer part;
providing at least one marker symbol indicative of a transition from one color component to another color component in the fine granularity scalability part for providing one or more marked fine granularity scalability parts;
encoding the one or more marked fine granularity scalability parts for providing an encoded fine granularity scalability part; and
combining the encoded base layer part and the encoded fine granularity scalability part into the bitstream.

2. The method of claim 1, wherein said at least one marker symbols occur and indicate offsets within the bitstream at which the transitions from one color component to another component occur.

3. The method of claim 1, wherein the video data in each color component in the bitstream has a length, and the marker symbol is indicative of the length of at least one color component.

4. The method of claim 1, wherein the video data for a given one of the color components in a plurality of frames is located consecutively in the bitstream and the marker symbol is indicative of an end of said given color component in said plurality of frames.

5. The method of claim 1, wherein the bitstream further comprises a flag, the flag indicating whether the video data from the color components is interleaved or whether the video data from each of the color components is arranged consecutively in the bitstream, and wherein said at least one marker symbol is decoded only if the flag is set.

6. The method of claim 1, wherein said at least one marker symbol is indicative of location of a given one of the color components, said method further comprising:
providing a different marker symbol indicative of resetting a coding state.

7. The method of claim 6, wherein the different marker symbol is decoded only when a given type of decoder is used to decode the video data.

8. The method of claim 7, further comprising:
providing a flag in the bitstream to indicate said given type of decoder.

9. The method of claim 1, wherein said at least one marker symbol is adapted to indicate the transition between a luminance color component and chrominance color components.

10. A method for decoding scalable video data from a bitstream of encoded data, said method comprising:
separating the encoded data into a base layer part and a fine granularity scalability part, wherein the fine granularity scalability part comprises at least one marker symbol indicative of a transition between a first color component and a second color component;
decoding the base layer part for providing a decoded base layer part; and
decoding the fine granularity scalability part.

11. The method of claim 10, wherein the fine granularity scalability part is decoded using decoded base layer part as reference.

12. The method of claim 10, wherein the first color component comprises a luminance color component and the second color component comprises chrominance color components.

13. The method of claim 10, wherein the fine granularity scalability part comprises at least a further marker symbol indicative of a location of said at least one marker symbol and wherein the fine granularity scalability part having the first color component is decoded also based on the further marker symbol.

14. The method of claim 10, wherein said at least one marker symbol comprises a plurality of markers, wherein the markers occur consecutively and indicate offsets in the bitstream at which the transitions between the first color component and the second color component occur.

15. The method of claim 10, wherein the video data in each color component in the bitstream has a length, and the marker symbol is indicative of the length of at least one color component.

16. The method of claim 1, wherein the bitstream further comprises a flag, the flag indicating whether the video data from the color components is interleaved or whether the video data from each of the color components is arranged consecutively in the bitstream, and wherein said at least one marker symbol is decoded only if the flag is set.

17. The method of claim 10, wherein said at least one marker symbol is indicative of a location of at least one of the first and second color components, and a different marker symbol indicative of resetting a coding state, said method further comprising:
providing a flag in the bitstream to indicate a given type of decoder; and
decoding the different marker symbol only when the video data is decoded using said given type of decoder.

18. A video encoder for encoding scalable video data, comprising:
a parser for separating the scalable video data into a base layer part and a fine granularity scalability part;
a module for placing at least one marker symbol indicative of a transition between one color component and another color component in the fine granularity scalability part for providing one or more marked fine granularity scalability parts;
a multiplexer module for encoding the base layer part and the one or more marked fine granularity scalability parts and for embedding the encoded base layer part and the encoded fine granularity scalability part into the bitstream.

19. The video encoder of claim 18, wherein the module is adapted for placing a further marker symbol indicative of location of said at least one marker symbol in the marked fine granularity scalability part.

20. The video encoder of claim 18, wherein said at least one marker symbol is indicative of location of one of the color components, and
wherein the module is adapted for placing a different marker symbol indicative of resetting a coding state and placing in the bitstream a flag indicative of a given type of decoder so that the different marker symbol is decoded only when the video data is decoded by said given type of decoder.

21. A mobile terminal comprising a video encoder according to claim 18.

22. A video decoder for decoding scalable video data from a bitstream, said decoder comprising:
a first module adapted:
for decoding a base layer part in the video data for providing a decoded base layer part, and
for decoding at least a luminance component in a fine granularity scalability part of the video data, wherein the fine granularity scalability part comprises at least one marker symbol indicative of a transition between the luminance component and chrominance components; and
a second module for detecting said at least one marker symbol so as to allow the first module to separate the luminance component from the chrominance components.

23. The video decoder of claim 22, wherein said decoding of the fine granularity scalability part is based on the decoded base layer part.

24. The video decoder of claim 22, wherein the fine granularity scalability part comprises at least a further marker symbol indicative of a location of said at least one marker symbol, and wherein the second module is adapted to detect the further marker symbol so that the decoding of said luminance part is based on the further marker symbol.

25. A mobile terminal comprising a video decoder according to claim 22.

26. A software application product comprising a storage medium having a software application for use in a video encoder for embedding scalable video data in a bitstream, said software application comprising:
programming code for providing at least one marker symbol indicative of a transition from one color component to another color component in the video data, wherein the video data comprises a base layer part and a fine granularity scalability part; and said at least one marker symbol is placed at least in the fine granularity scalability part.

27. The software application product of claim 26, wherein the software application further comprises:
programming code for placing a further marker symbol indicative of a location of said at least one marker symbol in the fine granularity scalability part.

28. The software application product of claim 26, wherein said at least one marker symbol is indicative of location of a given one of the color components, said software application further comprising:
programming code for placing a further marker symbol indicative of resetting a coding state, and
programming code for placing in the bitstream a flag indicative of a given type of decoder so that the further marker symbol is decoded only when the video data is decoded by said given type of decoder.

29. A software application product comprising a storage medium having a software application for use in a video decoder for decoding scalable video data in a bitstream, said software application comprising:
programming code for detecting at least one marker symbol indicative of a transition between one color component and another color component in the video data, wherein the video data comprises a base layer part and a fine granularity scalability part; and said at least one marker symbol is placed at least in the fine granularity scalability part.

30. The software application product of claim 29, wherein the software application further comprises:
programming code for detecting a further marker symbol indicative of a location of said at least one marker symbol in the fine granularity scalability part.

31. A video encoder for encoding scalable video data, comprising:
means for separating the scalable video data into a base layer part and a fine granularity scalability part;
means for placing at least one marker symbol indicative of a transition between one color component and another color component in the fine granularity scalability part for providing one or more marked fine granularity scalability parts; and
means for encoding the base layer part and the one and more marked fine granularity scalability parts and for embedding the encoded base layer part and the encoded fine granularity scalability part into the bitstream.

32. The video encoder of claim 31, wherein said placing means is adapted to provide a further marker symbol indicative of a location of said at least one marker symbol in the video data.

33. The video encoder of claim 31, wherein said placing means is adapted to provide a flag indicating whether the video data from the color components is interleaved or whether the video data for each of the color components is arranged consecutively in the bitstream, so that said at least one marker symbol is decoded only if the flag is set.

34. A video decoder for decoding scalable video data from a bitstream of encoded data, comprising:
means for separating the encoded data into a base layer part and a fine granularity scalability part, wherein the fine granularity scalability part comprises at least one marker symbol indicative of a transition between a luminance component and chrominance components;
means for decoding the base layer part for providing a decoded base layer part; and decoding the fine granularity scalability part using the decoded base layer part as reference.

35. The video decoder of claim 34, wherein the fine granularity scalability part comprises at least a further marker symbol indicative of a location of said at least one marker symbol and wherein the fine granularity scalability part having the first color component is decoded also based on the further marker symbol.

36. The video decoder of claim 34, wherein said at least one marker symbol comprises a plurality of markers, wherein the markers occur consecutively and indicate offsets in the bitstream at which the transitions between the first color component and the second color component occur.
